(19) United States
(12) Patent Application Publication
(10) Pub. No.: US 2026/0096007 A1
(43) Pub. Date: Apr. 2, 2026

(54) CYCLOTRONS, ADJUSTMENT UNITS, ADJUSTMENT DEVICES OF SUPERCONDUCTING COILS, AND ADJUSTMENT METHODS THEREOF

(71) Applicant: MEVION MEDICAL EQUIPMENT CO., LTD., Suzhou (CN)

(72) Inventors: Guojun LI, Suzhou (CN); Qi WEN, Suzhou (CN)

(73) Assignee: MEVION MEDICAL EQUIPMENT CO., LTD., Suzhou (CN)

(21) Appl. No.: 19/411,426

(22) Filed: Dec. 8, 2025

Related U.S. Application Data
(63) Continuation of application No. PCT/CN2025/098783, filed on Jun. 3, 2025.

(30) Foreign Application Priority Data
Jun. 7, 2024 (CN) 202410738102.7

(51) Int. Cl. H05H 7/04; H05H 13/00

(52) U.S. Cl. CPC H05H 7/04; H05H 13/005; H05H 2277/11

(57) ABSTRACT

The present disclosure relates to a cyclotron, a radiation therapy apparatus, an adjustment unit, an adjustment device of a superconducting coil, and an adjustment method thereof. The adjustment unit includes a rotating shaft, a drive assembly, a transmission assembly, and a detection element. The rotating shaft is capable of rotating driven by an external drive unit; the drive assembly includes an actuator and a tension assembly, the actuator being configured to drive the tension assembly to move linearly through rotation, and one end of the tension assembly being connected to a superconducting coil and capable of driving the superconducting coil to move; the transmission assembly is connected to the rotating shaft and the actuator, respectively, and configured to transmit power to the actuator; and the detection element is connected to the actuator and configured to monitor a displacement of the tension assembly and a displacement of the superconducting coil.

### CROSS REFERENCE TO RELATED APPLICATIONS

This application is a continuation of International Patent Application No. PCT/CN2025/098783, filed on June 3, 2025, which claims priority to Chinese Patent Application No. 202410738102.7, filed on June 7, 2024, the entire contents of each of which are incorporated herein by reference.

### TECHNICAL FIELD

The present disclosure relates to the technical field of proton therapy equipment, and in particular, to a cyclotron, an adjustment unit, an adjustment device of a superconducting coil, and an adjustment method for the superconducting coil.

### BACKGROUND

In small-scale integrated proton therapy equipment, a cyclotron is generally employed to output a proton beam to irradiate a patient’s lesion site. To allow the proton beam to be emitted from different angles, the cyclotron in the prior art needs to perform reciprocating rotational motion within a certain angular range under the drive of the gantry.

Since the superconducting coil in the cyclotron is generally in a suspended state to reduce the impact of heat transfer on its operating conditions, the superconducting coil may shift during the rotation of the cyclotron, thereby causing the central axis of the magnetic field generated by the superconducting coil to become misaligned with the physical central axis of the cyclotron. As a result, the proton beam may also deviate during acceleration within the cyclotron, which may result in the proton beam failing to exit through the beam outlet of the cyclotron, or only a portion of the proton beam exiting. Consequently, the beam current of the proton beam emitted from the cyclotron may fail to meet the requirements.

### SUMMARY

The object of the present disclosure is to provide a cyclotron, a radiation therapy device, an adjustment unit, an adjustment device of a superconducting coil, and an adjustment method for a superconducting coil for adjusting a position of a superconducting coil so that the superconducting coil can be adjusted to a desired position.

The purpose of the present disclosure is realized using the following technical solution: an adjustment unit of a superconducting coil is provided, comprising: a rotating shaft connected to an external drive unit and capable of rotating driven by the external drive unit; a drive assembly including an actuator and a tension assembly connected to each other, the actuator being configured to drive the tension assembly to move linearly through rotation, and one end of the tension assembly being connected to a superconducting coil and capable of driving the superconducting coil to move; a transmission assembly connected to the rotating shaft and the actuator, respectively, and the transmission assembly being configured to drive at least a portion of the actuator to rotate by transmitting power generated by the rotating shaft to the actuator; and a detection element connected to the actuator and configured to monitor a displacement of the tension assembly and a displacement of the superconducting coil by detecting a rotation angle of the actuator.

In some embodiments, the transmission assembly includes a drive gear sleeved onto the rotating shaft and a driven gear fixedly connected to the actuator, and the drive gear is engaged with the driven gear to transmit the power from the rotating shaft to the actuator; and/or the actuator is a differential screw, and an inner wheel of the differential screw is positioned lower than an outer wheel of the differential screw along a height direction of the adjustment unit.

In some embodiments, the tension assembly is connected to a pressure detection member, and the pressure detection member is configured to detect a force exerted by the tension assembly on the superconducting coil; and/or the detection element is a potentiometer.

In some embodiments, the adjustment unit further comprises a limiting member and a housing, the limiting member is connected to the tension assembly, the housing includes a limiting space for accommodating the limiting member, a wall of the limiting space is at least partially overlapped with the limiting member along a movement direction of the tension assembly, so that the wall of the limiting space limits a movement range of the limiting member; and/or the housing is provided with a convex column capable of extending into the limiting space, and the convex column is disposed at one end of the tension assembly facing the superconducting coil to limit a movement range of the tension assembly.

In some embodiments, one end of the tension assembly connected to the superconducting coil is provided with a connecting portion and a fixing member, the connecting portion includes a connecting cavity and a fixing hole in communication with the connecting cavity, the connecting cavity accommodates an adjustment assembly connected to the superconducting coil, and the fixing member inserts into the connecting cavity through the fixing hole and fixes the adjustment assembly.

An adjustment device of a superconducting coil, comprising: an adjustment unit; the external drive unit connected to the rotating shaft of the adjustment unit and configured to drive the rotating shaft to rotate; and an adjustment assembly, with one end connected to the superconducting coil and the other end connected to the tension assembly of the adjustment unit, and the tension assembly being configured to drive the superconducting coil to move through the adjustment assembly.

In some embodiments, the adjustment device further comprises a control unit, the control unit is connected to the detection element and the external drive unit and the control unit is configured to receive detection information from the detection element and control an operation of the external drive unit.

In some embodiments, one end of the tension assembly connected to the superconducting coil is provided with a connecting portion and a fixing member; the adjustment assembly includes a tension rod, a first fitting member, and a second fitting member, the first fitting member and the second fitting member are arranged on opposite ends of the tension rod, respectively, the first fitting member is connected to the superconducting coil, and the second fitting member is connected to the connecting portion of the tension assembly and is fixed relative to the tension assembly through the fixing member.

A cyclotron is provided, comprising: at least one adjustment device of a superconducting coil of any one of the foregoing; the superconducting coil; and a mounting bracket, provided with a mounting space for accommodating the superconducting coil, and the mounting bracket includes at least one mating portion for mating with the at least one adjustment device, and the at least one adjustment device is configured to adjust a position of the mounting bracket and a position of the superconducting coil mounted inside the mounting bracket through the at least one mating portion.

In some embodiments, the cyclotron includes at least one adjustment device pair, two adjustment devices of an adjustment device pair of the at least one adjustment device pair is arranged at opposite ends of the superconducting coil, respectively, and the adjustment device pair is configured to adjust a position of the superconducting coil along an X-axis, a Y-axis, or a Z-axis, and the X-axis, Y-axis, and Z-axis are mutually perpendicular and intersect at a physical center of the cyclotron.

In some embodiments, the cyclotron further comprises a plurality of magnetic field detection members, and the plurality of magnetic field detection members are spaced apart to measure magnetic field intensities at a plurality of positions within the cyclotron; or the cyclotron further comprises a magnetic field detection device, the magnetic field detection device includes a detection end and a drive component, the detection end is configured to detect a magnetic field intensity at a position where the detection end is located, and the drive component is configured to drive the detection end to move so as to measure the magnetic field intensities at a plurality of positions within the cyclotron.

An adjustment method for a superconducting coil is provided, which is applied to the cyclotron of any of the foregoing, and the adjustment method comprises: obtaining an offset of the superconducting coil and obtaining a required adjustment amount for each of the at least one adjustment device based on the offset of the superconducting coil; and controlling, by each of the at least one adjustment device, an operation of the external drive unit based on the required adjustment amount to drive the superconducting coil to be adjusted to a specified position.

In some embodiments, the adjustment method further comprises: monitoring, by the detection element, a rotation angle of the actuator driven by the external drive unit to obtain an actual adjustment amount of each of the at least one adjustment device, and stopping the external drive unit in response to determining that the actual adjustment amount of each of the at least one adjustment device is the same as the required adjustment amount for each of the at least one of adjustment device.

A radiation therapy apparatus is provided, comprising a cyclotron of any one of the foregoing.

Using the cyclotron, the adjustment unit, the adjustment device, and the adjustment method provided by the present disclosure has at least the following advantages.

The position of the superconducting coil can be adjusted by employing the tension assembly of the drive assembly to connect to the superconducting coil and drive the superconducting coil to move. When the superconducting coil shifts, the adjustment unit provided by the present disclosure can be employed to adjust the superconducting coil to a desired position. Moreover, by employing the detection element for detecting the displacement of the tension assembly and the displacement of the superconducting coil, the adjustment precision of the adjustment unit for the superconducting coil can be ensured, which consequently guarantees that the beam emitted from the cyclotron can meet the requirements, thereby ensuring precise radiation treatment.

### BRIEF DESCRIPTION OF THE DRAWINGS

FIG. 1 is a schematic diagram illustrating an exemplary structure of an adjustment unit of a superconducting coil according to some embodiments of the present disclosure;

FIG. 2 is a schematic diagram illustrating an exemplary cross-section of an adjustment unit of a superconducting coil according to some embodiments of the present disclosure;

FIG. 3 is a schematic diagram illustrating an exemplary structure of a portion of an adjustment unit of a superconducting coil according to some embodiments of the present disclosure;

FIG. 4 is a schematic diagram illustrating an exemplary structure of an adjustment device of a superconducting coil according to some embodiments of the present disclosure; and

FIG. 5 is a schematic diagram illustrating an exemplary local structure of an adjustment device of a superconducting coil according to some embodiments of the present disclosure.

Reference Signs: 100: adjustment unit of a superconducting coil; 1, rotating shaft; 11, notch; 2, drive assembly; 21, actuator; 211, adjustment hole; 22, tension assembly; 221, connecting portion; 2211, connecting cavity; 2212, fixing hole; 222, fixing member; 223, tension cup; 224, pull rod; 2241, first rod segment; 2242, second rod segment; 225, hexagonal cover plate; 3, transmission assembly; 31, drive gear; 32, driven gear; 4, detection element; 5, pressure detection member; 6, limiting member; 7, housing; 71, limiting space; 72, convex column; 200, external drive unit; 201, motor; 202, transmission rod; 300, adjustment assembly; 301, tension rod; 302, first fitting member; 303, second fitting member.

### DETAILED DESCRIPTION

Exemplary embodiments will now be described more fully with reference to the accompanying drawings. However, the exemplary embodiments may be implemented in various forms and should not be construed as being limited to the embodiments described herein. Rather, the description of these embodiments is provided to make the present disclosure more comprehensive and complete, and to fully convey the concepts of the exemplary embodiments to those skilled in the art. Like reference numerals in the figures denote like or similar structures, and thus redundant descriptions thereof will be omitted.

Words expressing position and orientation described in the present disclosure are illustrated by the accompanying drawings, but changes may be made as needed, and the changes made are included in the scope of protection of the present disclosure.

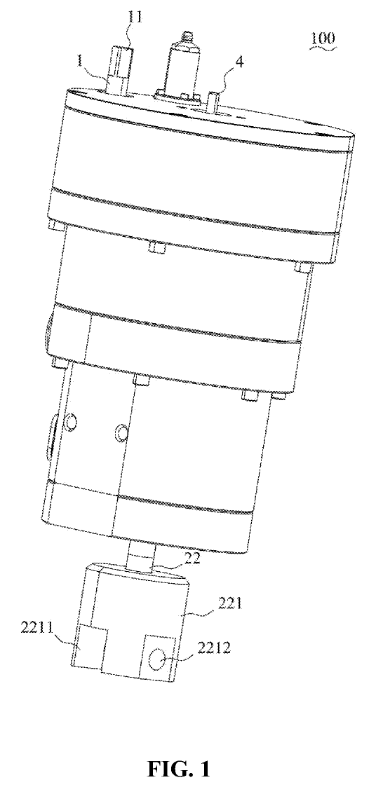

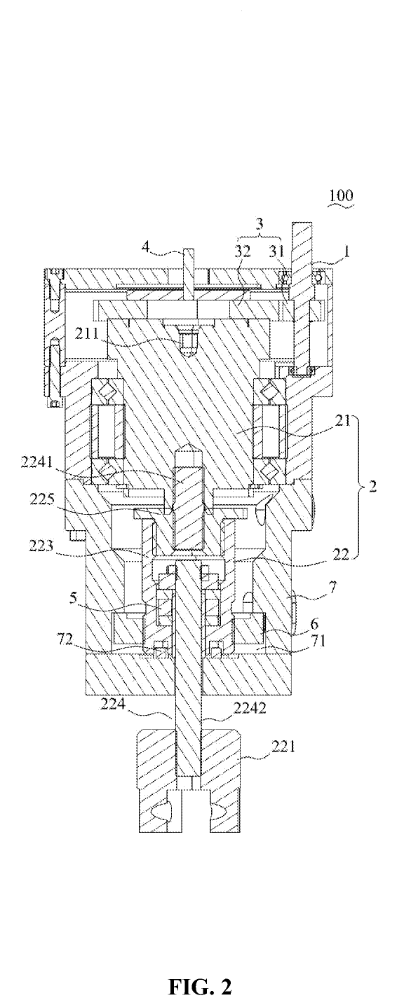

As shown in FIG. 1 and FIG. 2, the present disclosure provides an adjustment unit 100 of a superconducting coil (also referred to as the adjustment unit 100). The adjustment unit 100 includes a housing 7, a rotating shaft 1, a drive assembly 2 connected to the rotating shaft 1, a transmission assembly 3, and a detection element 4. The rotating shaft 1 may be connected to an external drive unit 200. The transmission assembly 3 is connected to the drive assembly 2 and the rotating shaft 1, respectively, and is capable of transmitting power. The detection element 4 is configured to detect a movement amount of the drive assembly 2.

The housing 7 may accommodate at least a portion of the rotating shaft 1, the drive assembly 2, the transmission assembly 3, and the detection element 4. Specifically, one end of the rotating shaft 1 for connecting to the transmission assembly 3 is accommodated within the housing 7, and one end of the rotating shaft 1 for connecting to the external drive unit 200 is exposed outside the housing 7. A main portion of the drive assembly 2 is accommodated within the housing 7, and one end of the drive assembly 2 for connecting to the superconducting coil is exposed outside the housing 7. The detection element 4 and the transmission assembly 3 may be completely accommodated within the housing 7, resulting in a more compact overall structure of the adjustment unit 100.

The rotating shaft 1 is capable of rotating driven by the external drive unit 200, and the rotating shaft 1 may transmit power to the drive assembly 2 through the transmission assembly 3. The end of the rotating shaft 1 for connecting to the external drive unit 200 is provided with a notch 11, the notch 11 is recessed radially inward from an outer wall of the rotating shaft 1, and the notch 11 may mate with the external drive unit 200 to prevent a relative rotation between the rotating shaft 1 and the external drive unit 200.

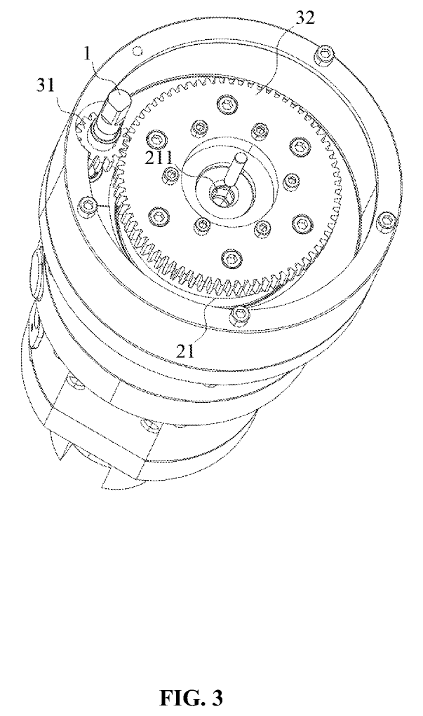

Referring to FIG. 2 and FIG. 3, the transmission assembly 3 may include a drive gear 31 and a driven gear 32 that engage with each other. The drive gear 31 may be sleeved onto the rotating shaft 1, and the drive gear 31 may rotate synchronously with the rotating shaft 1. Specifically, the drive gear 31 and the rotating shaft 1 are relatively fixed by means of an interference fit, screw fastening, or the like, so that the drive gear 31 and the rotating shaft 1 can rotate synchronously. The driven gear 32 may be driven to rotate by the drive gear 31, and the driven gear 32 is fixedly connected to the drive assembly 2 so that the driven gear 32 may drive at least a portion of the drive assembly 2 to rotate synchronously. Specifically, a diameter of the driven gear 32 is greater than a diameter of the drive gear 31, and according to a gear tooth number ratio between the driven gear 32 and the drive gear 31, a transmission ratio of the transmission assembly 3 may be obtained, and thus a rotation angle ratio between the rotating shaft 1 and at least a portion of the drive assembly 2 may be obtained.

Referring to FIG. 2, the drive assembly 2 may include an actuator 21 and a tension assembly 22 connected to each other. The actuator 21 is fixedly connected to the driven gear 32. For example, the actuator 21 and the driven gear 32 are fixedly connected by fasteners such as screws. The actuator 21 rotates together with the driven gear 32 under the driving of the driven gear 32, and the actuator 21 may convert a rotation into a linear motion. The tension assembly 22 is connected to the actuator 21, and when the actuator 21 converts the rotation into the linear motion, the tension assembly 22 connected to the actuator 21 may be driven to move linearly. One end of the tension assembly 22 may be directly or indirectly connected to the superconducting coil to drive the superconducting coil to move, thereby adjusting a position of the superconducting coil. The actuator 21 may be a differential screw, where an outer wheel of the differential screw is connected to the driven gear 32 to rotate synchronously with the driven gear 32, and an inner wheel of the differential screw is in threaded engagement with the outer wheel to convert a rotation of the outer wheel into a linear motion of the inner wheel; and the tension assembly 22 is connected to the inner wheel of the differential screw to enable the actuator 21 to drive the tension assembly 22 to move linearly.

In some embodiments, to increase an adjustment stroke of the drive assembly 2 for the superconducting coil, when the actuator 21 is the differential screw, the inner wheel of the differential screw is positioned lower than the outer wheel of the differential screw along a height direction of the adjustment unit 100 to allow the inner wheel of the differential screw to have a greater travel stroke, thereby increasing the adjustment stroke of the drive assembly 2 for the superconducting coil. To adjust the height difference between the inner wheel and the outer wheel of the differential screw, the inner wheel of the differential screw is provided with an adjustment hole 211 that may be fitted with a wrench, and the wrench may be inserted into the adjustment hole 211 to adjust the inner wheel of the differential screw, so that the inner wheel of the differential screw may be positioned lower than the outer wheel of the differential screw along the height direction of the adjustment unit 100.

In some embodiments, the tension assembly 22 includes a tension cup 223, a pull rod 224, and a hexagonal cover plate 225. The pull rod 224 may be connected to the actuator 21 and the superconducting coil, respectively. Specifically, the pull rod 224 may include a first rod segment 2241 and a second rod segment 2242. One end of the first rod segment 2241 is connected to the actuator 21, and the other end is connected to the hexagonal cover plate 225. The hexagonal cover plate 225 is connected to the tension cup 223. One end of the second rod segment 2242 is connected to the tension cup 223, and the other end of the second rod segment 2242 is connected directly or indirectly to the superconducting coil. Therefore, a driving force generated by the actuator 21 may be transmitted sequentially through the first rod segment 2241 of the pull rod 224, the hexagonal cover plate 225, the tension cup 223, and the second rod segment 2242 of the pull rod 224 to the superconducting coil, thereby adjusting the position of the superconducting coil.

Referring to FIG. 1, in some embodiments, the tension assembly 22 may be indirectly connected to the superconducting coil. For example, the second rod segment 2242 of the pull rod 224 of the tension assembly 22 is connected to an adjustment assembly 300 that is connected to the superconducting coil, which enables the tension assembly 22 to be connected to the superconducting coil through the adjustment assembly 300. Specifically, one end of the tension assembly 22 for connecting to the superconducting coil is provided with a connecting portion 221 and a fixing member 222, i.e., one end of the second rod segment 2242 of the pull rod 224 facing the superconducting coil is provided with the connecting portion 221 and the fixing member 222. The connecting portion 221 includes a connecting cavity 2211 and a fixing hole 2212 in communication with the connecting cavity 2211. The connecting cavity 2211 accommodates a portion of the adjustment assembly 300. The connecting cavity 2211 may be formed as a recess from an end surface of the connecting portion 221 that faces the superconducting coil to allow the adjustment assembly 300 to be inserted into the connecting cavity 2211 from one end of the connecting portion 221 that faces the superconducting coil. The fixing hole 2212 may penetrate through the connecting portion 221 along a radial direction of the tension assembly 22, and the fixing hole 2212 may be in communication with the connecting cavity 2211. The fixing hole 2212 is configured for the fixing member 222 to pass through, and at least a portion of the fixing hole 2212 may mate with the fixing member 222 to realize a fixed connection between the fixing member 222 and the connecting portion 221 formed with the fixing hole 2212. For example, a portion of the fixing hole 2212 forms a threaded hole, the fixing member 222 is a screw, and the fixing member 222 may be threadedly mated with the fixing hole 2212 to realize the fixed connection between the fixing member 222 and the connecting portion 221. As another example, a portion of the fixing hole 2212 forms an interference fit with the fixing member 222 to realize the fixed connection between the fixing member 222 and the connecting portion 221. When a portion of the adjustment assembly 300 is inserted into the connecting cavity 2211, the fixing member 222 may pass through the fixing hole 2212 and the adjustment assembly 300 and be fixedly connected to the tension assembly 22. At the same time, the adjustment assembly 300 sleeved onto the fixing member 222 remains relatively fixed to the connecting portion 221, which in turn allows the adjustment assembly 300 to remain relatively fixed to the tension assembly 22. For example, the adjustment assembly 300 remains relatively fixed to the tension assembly 22 at least along an axial direction of the tension assembly 22.

In some embodiments, the tension assembly 22 may be connected to a pressure detection member 5. When the tension assembly 22 moves, a force is applied to the superconducting coil by the tension assembly 22 to adjust the position of the superconducting coil. The pressure detection member 5 may be configured to detect the force applied to the superconducting coil by the tension assembly 22 so as to adjust the position of the superconducting coil correspondingly. Specifically, the tension cup 223 and the hexagonal cover plate 225 of the tension assembly 22 may together enclose a mounting space for accommodating the pressure detection member 5, the pressure detection member 5 is accommodated within the mounting space enclosed by the tension cup 223 and the hexagonal cover plate 225, and the pressure detection member 5 may be sleeved onto the second rod segment 2242 of the pull rod 224. When the tension assembly 22 applies a force to the superconducting coil, the pressure detection member 5 mounted to the tension assembly 22 may detect the force applied by the tension assembly 22 to the superconducting coil.

Referring to FIG. 2, in some embodiments, to limit an adjustment amount of the adjustment unit 100 for the superconducting coil and to prevent excessive adjustment of the position of the superconducting coil by the adjustment unit 100, the adjustment unit 100 further includes a limiting member 6. The limiting member 6 is fixedly connected to the tension assembly 22. For example, the limiting member 6 is sleeved onto the tension cup 223 of the tension assembly 22 and forms an interference fit with the tension cup 223 of the tension assembly 22. A limiting space 71 is formed within the housing 7 for accommodating the limiting member 6; the limiting space 71 extends along a movement direction of the tension assembly 22, e.g., along an axis of the tension assembly 22. A wall of the limiting space 71 is at least partially overlapped with the limiting member 6 along the movement direction of the tension assembly 22 so that the limiting member 6 abuts against the wall of the limiting space 71 when the limiting member 6 moves. Therefore, the wall of the limiting space 71 limits a movement range of the limiting member 6 while limiting a movement range of the tension assembly 22 at the same time. In some embodiments, the wall of the limiting space 71 limits opposite ends of the limiting member 6 along the movement direction of the tension assembly 22.

In some embodiments, the housing 7 may be provided with a convex column 72 capable of extending into the limiting space 71, and the convex column 72 may be disposed at one end of the tension assembly 22 facing the superconducting coil so that the convex column 72 may limit the movement range of the tension assembly 22 along a direction toward the superconducting coil. Specifically, the convex column 72 is disposed at one end of the tension cup 223 facing the superconducting coil, and the convex column 72 may abut against the tension cup 223 to limit further movement of the tension cup 223 along the direction toward the superconducting coil, which in turn limits the movement range of the tension assembly 22 along the direction toward the superconducting coil.

The detection element 4 is connected to the actuator 21 and is configured to detect a rotation angle of the actuator 21. The rotation angle of the actuator 21 is positively correlated with a movement amount of the tension assembly 22, and a displacement of the tension assembly 22 may be determined based on the rotation angle of the actuator 21, which in turn obtains a displacement of the superconducting coil driven by the tension assembly 22. For example, when the actuator 21 is in threaded engagement with the tension assembly 22 to convert a rotational motion into a linear motion, based on thread parameters corresponding to the actuator 21 and the tension assembly 22, a displacement of the tension assembly 22 after the actuator 21 is rotated by a certain angle may be determined according to an existing calculation manner. Accordingly, the displacement of the superconducting coil driven by the tension assembly 22 may be obtained. In some embodiments, the detection element 4 may be a potentiometer. When the drive assembly 2 moves, the detection element 4 may detect the rotation angle of the actuator 21 in real time to monitor the displacement of the tension assembly 22 and the displacement of the superconducting coil in real time.

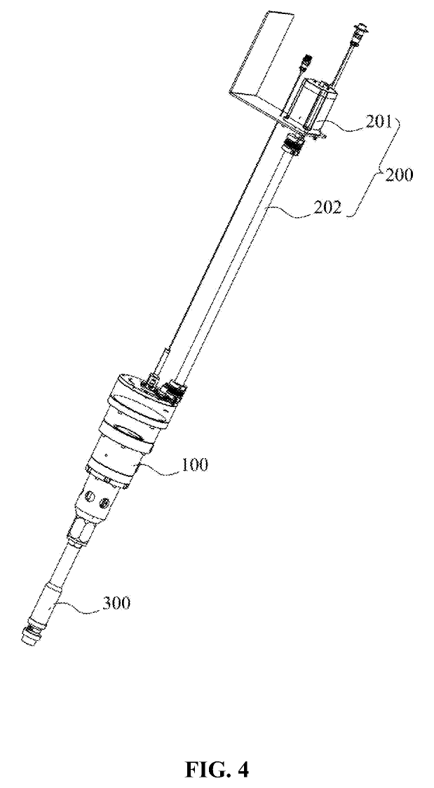

Referring to FIG. 4, the present disclosure further provides an adjustment device of a superconducting coil. The adjustment device includes the adjustment unit 100, the external drive unit 200, the adjustment assembly 300 connected to the superconducting coil and the tension assembly 22, and a control unit. The external drive unit 200 is connected to the rotating shaft 1 of the adjustment unit 100 and configured to drive the rotating shaft 1 to rotate.

One end of the adjustment assembly 300 is connected to the tension assembly 22 such that the tension assembly 22 may drive the adjustment assembly 300 to move; the other end of the adjustment assembly 300 is directly or indirectly connected to the superconducting coil, and the adjustment assembly 300 may drive the superconducting coil to move through power transmitted by the tension assembly 22, thereby adjusting a position of the superconducting coil.

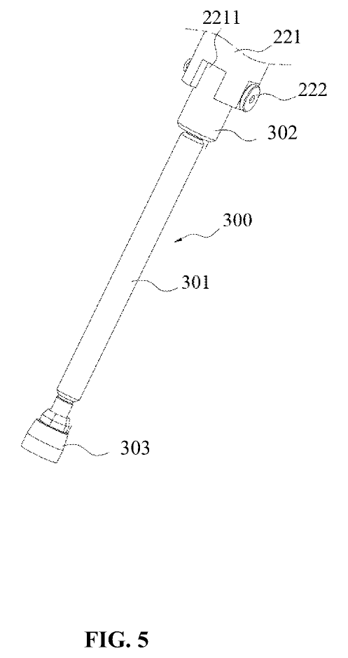

Referring to FIG. 5, in some embodiments, the adjustment assembly 300 may include a tension rod 301, a first fitting member 302, and a second fitting member 303. The first fitting member 302 and the second fitting member 303 are arranged on opposite ends of the tension rod 301, respectively. The first fitting member 302 is fixedly connected to one end of the tension rod 301 facing away from the superconducting coil. For example, the first fitting member 302 is threadedly connected to the end of the tension rod 301 facing away from the superconducting coil. The first fitting member 302 is also connected to the connecting portion 221 of the tension assembly 22. Specifically, a portion of the first fitting member 302 extends into the connecting cavity 2211 of the connecting portion 221, and the portion of the first fitting member 302 that extends into the connecting cavity 2211 is provided with a through-hole that engages with the fixing member 222. When the first fitting member 302 extends into the connecting cavity 2211, the fixing member 222 may pass through the fixing hole 2212 of the connecting portion 221 and the through-hole of the first fitting member 302 and be fixedly connected to the connecting portion 221 to realize a relative fixation between the first fitting member 302 and the connecting portion 221. The second fitting member 303 is connected directly or indirectly to the superconducting coil. When the tension assembly 22 moves, the tension assembly 22 applies a force to the tension rod 301 through the first fitting member 302, after which the tension rod 301 transmits the force to the second fitting member 303 to act on the superconducting coil.

The control unit is connected to the detection element 4 and the external drive unit 200, respectively. The information detected by the detection element 4 may be transmitted to the control unit to enable the control unit to obtain an actual displacement of the tension assembly 22 and an actual displacement of the superconducting coil. The control unit may control the external drive unit 200 based on the actual displacement of the tension assembly 22. Specifically, when the position of the superconducting coil needs to be adjusted, to make the superconducting coil move to a specified position, it is necessary to drive the tension assembly 22 to move by a required distance. At this time, the control unit controls the external drive unit 200 to move and detects a displacement of the tension assembly 22 in real time through the detection element 4, and when the displacement of the tension assembly 22 is the same as the required distance for the tension assembly 22, the control unit controls the external drive unit 200 to stop moving. The external drive unit 200 may include a motor 201 and a transmission rod 202 connected to the motor 201. The motor 201 drives the transmission rod 202 to rotate, and one end of the transmission rod 202 is sleeved onto the rotating shaft 1 of the adjustment unit 100 to drive the rotating shaft 1 to move synchronously.

The control unit may be any applicable computing device, such as a personal computer, a server, a programmable logic controller (PLC controller), a microcontroller, an upper computer, etc., or may be an integration of computing devices. The control unit may have a function such as receiving information, sending a control command, or the like, and the control unit may control each component to perform a corresponding action through wired communication or wireless communication.

The present disclosure further provides a cyclotron. The cyclotron includes the adjustment device as described above, a superconducting coil, a mounting bracket (not shown in the figures) for mounting the superconducting coil, and a yoke.

The mounting bracket is provided with a mounting space for accommodating the superconducting coil, and the superconducting coil may be suspended within the yoke after being mounted within the mounting bracket. The mounting bracket may be connected to the adjustment device to enable the adjustment device to adjust a position of the mounting bracket, thereby adjusting the position of the superconducting coil mounted within the mounting bracket. The mounting bracket may be a coil skeleton within a cryostat.

To facilitate a connection between the mounting bracket and the adjustment device, an outer wall of the mounting bracket may be provided with a mating portion that engages with the adjustment device, and the adjustment device adjusts the position of the mounting bracket and the position of the superconducting coil mounted within the mounting bracket by applying a force to the mating portion. The mating portion mates with the second fitting member 303 in the adjustment assembly 300 of the adjustment device. The mating portion may include a threaded post and a nut threadedly connected to the threaded post, and the second fitting member 303 may be sleeved onto the nut of the mating portion. For example, the second fitting member 303 is provided with a mating cavity that mates with the nut, and a shape of the mating cavity is the same as or similar to a shape of the nut, so that when the second fitting member 303 is sleeved onto the nut, the nut may be driven to move synchronously with the second fitting member 303 and thus realize the adjustment of the mating portion.

The mounting bracket may be provided with one or more mating portions, one or more adjustment devices may be correspondingly provided, and each of the one or more mating portions may be connected to one of the one or more adjustment devices. In some embodiments, the mounting bracket is provided with at least one mating portion pair, and at least one adjustment device pair is correspondingly provided. Two mating portions of a mating portion pair of the at least one mating portion pair are arranged at opposite ends of the superconducting coil, respectively, and two adjustment devices of the adjustment device pair connected to the mating portion pair are arranged at opposite ends of the superconducting coil, respectively, which enables the adjustment device pair to adjust the position of the superconducting coil along an axis through the mating portion pair.

Specifically, when the position of the superconducting coil needs to be adjusted along an X-axis during an operation of the cyclotron, the mating portion may be disposed at each of opposite ends of the mounting bracket along the X-axis, and each mating portion is connected to one adjustment device. Therefore, one adjustment device pair may adjust the position of the superconducting coil in either the positive or negative direction along the X-axis. When the position of the superconducting coil needs to be adjusted along a Y-axis and/or a Z-axis during the operation of the cyclotron, the mating portion may be disposed at each of opposite ends of the mounting bracket along the Y-axis and/or Z-axis, and each mating portion is connected to one adjustment device. The X-axis, the Y-axis, and the Z-axis may be perpendicular to each other, and the X-axis, the Y-axis, and the Z-axis may intersect at a physical center of the cyclotron.

In some embodiments, to facilitate the detection of whether the position of the superconducting coil shifts, the cyclotron may be provided with a plurality of magnetic field detection members. The plurality of magnetic field detection members may be spaced apart at different positions of the cyclotron to measure magnetic field intensities at a plurality of positions within the cyclotron, and magnetic field information detected by the plurality of magnetic field detection members may be fed back to the control unit of the adjustment device. The control unit determines whether the position of the superconducting coil shifts based on the magnetic field information detected by the plurality of magnetic field detection members, and the control unit may further determine an offset of the superconducting coil based on the magnetic field information detected by the plurality of magnetic field detection members, which in turn controls a corresponding adjustment device operates to adjust the position of the superconducting coil. The magnetic field detection member may be a Hall sensor for detecting a magnetic field.

The control unit may pre-store magnitudes and shapes of magnetic fields detected by the plurality of magnetic field detection members when the superconducting coil is located at a specified position (where the center axis of the superconducting coil is concentric with the physical center axis of the cyclotron). Subsequently, during the operation of the cyclotron, the plurality of magnetic field detection members detect magnetic fields at a corresponding position in real time, and the control unit obtains magnitudes and shapes of actual magnetic fields detected by the plurality of magnetic field detection members in real time. It is known that there exist two cases, including the magnitudes and shapes of the actual magnetic fields differ from the magnitudes and shapes of the magnetic field pre-stored by the control unit, and the magnitudes and shapes of the actual magnetic fields are the same as the magnitudes and shapes of the magnetic fields pre-stored by the control unit. By comparing the magnitudes and shapes of the actual magnetic fields with the magnitudes and shapes of the magnetic fields pre-stored by the control unit, in response to determining that the magnitudes and shapes of the actual magnetic fields differ from the magnitudes and shapes of the magnetic fields pre-stored by the control unit, it may be determined that the superconducting coil shifts; and in response to determining that the magnitudes and shapes of the actual magnetic fields are the same as the magnitudes and shapes of the magnetic fields pre-stored by the control unit, it may be determined that the superconducting coil is located at a specified position. In addition, according to a change amount between the magnitudes and shapes of the actual magnetic fields and the magnitudes and shapes of the magnetic fields pre-stored by the control unit, a specific or substantial offset of the superconducting coil may be determined. For example, an offset of the superconducting coil along the X-axis, Y-axis, and Z-axis may be determined, respectively, after which the position of the superconducting coil may be adjusted by adjusting an adjustment device disposed along the corresponding axis.

In some embodiments, the cyclotron may also be provided with a magnetic field detection device to detect magnetic field intensities at a plurality of different positions within the cyclotron. The magnetic field detection device includes a detection end and a drive component. The detection end is configured to detect a magnetic field intensity at a position where the detection end is located. The drive component is configured to drive the detection end to move so that the detection end may be moved to a plurality of positions within the cyclotron, thereby measuring the magnetic field intensities at the plurality of positions within the cyclotron. The detection end may be a Hall sensor for detecting a magnetic field.

The present disclosure further provides an adjustment method for a superconducting coil, which can be applied to the cyclotron described above. The adjustment method includes the following operation 01, operation 02, and operation 03.

Operation 01: an offset of a superconducting coil may be obtained, and a required adjustment amount for each of at least one adjustment device based on the offset of the superconducting coil may be obtained;

Operation 02: each of the at least one adjustment device may control an operation of the external drive unit 200 based on the required adjustment amount to drive the superconducting coil to be adjusted to a specified position; and

Operation 03: the detection element 4 may monitor a rotation angle of the actuator 21 driven by the external drive unit 200 to obtain an actual adjustment amount of each of the at least one adjustment device, and the external drive unit may stop in response to determining that the actual adjustment amount of each of the at least one adjustment device is the same as the required adjustment amount for each of the at least one of adjustment device.

In operation 01, the offset of the superconducting coil may be determined based on magnetic field information detected by the plurality of magnetic field detection members or the magnetic field detection device disposed within the cyclotron. An accurate value of the offset of the superconducting coil may be directly obtained to indicate an adjustment amount for the adjustment device; or, an approximate range of the offset of the superconducting coil may be obtained to indicate the adjustment device to perform initial adjustment on the superconducting coil. Thereafter, the magnetic field information detected by the plurality of magnetic field detection members or the magnetic field detection device is analyzed in real time to determine an offset between the superconducting coil and a predetermined position. According to changes in the position of the superconducting coil, the offset of the superconducting coil is obtained in real time, which indicates the adjustment device to adjust the superconducting coil in real time.

In operation 02, the adjustment amount for the adjustment device is positively correlated with a movement distance of the tension assembly 22 of the drive assembly 2, and according to the required adjustment amount for the adjustment device, a required movement distance for the tension assembly 22 may be obtained, and thus a required rotation angle for the actuator 21 may be obtained. The actuator 21 is driven by the external drive unit 200 to rotate based on the required rotation angle to adjust the superconducting coil to the specified position.

Operation 03 may be carried out with operation 02 at the same time, and the detection element 4 is configured to detect a rotation angle of the actuator 21 in real time. In response to determining that the real-time rotation angle of the actuator 21 is the same as the required rotation angle for the actuator 21 and the actual adjustment amount of the adjustment device is the same as the required adjustment amount for the adjustment device, the external drive unit 200 stops operating.

The present disclosure further provides a radiation therapy apparatus including a treatment gantry (not shown in the figures), a particle accelerator (not shown in the figures) for generating a particle beam, a scanning magnet (not shown in the figures), an ionization chamber (not shown in the figures), and a range modulator (not shown in the figures). The treatment gantry includes an arm. The particle accelerator may be the cyclotron described above. The radiation therapy apparatus may be configured without a beam transport line. The particle accelerator is mounted on the treatment gantry and is rotatable together with the treatment gantry, and the treatment gantry may also be referred to as a rotating gantry. In some embodiments, the radiation therapy apparatus is a proton therapy device, the particle accelerator may be a proton accelerator, and the particle beam may be a proton beam. A flowing particle beam is referred to as the particle beam. A particle beam transport system is configured to transport the particle beam from the accelerator to the patient’s body. Through magnetic field control, the particle beam transport system precisely guides the particle beam to a treatment position, ensuring accurate positioning and transport of the particle beam. The particle beam transport system may include components encountered during the particle beam transport process, such as a scanning magnet, an ionization chamber, and an adaptive collimator. The scanning magnet, by appropriately changing the magnetic field, allows the particle beam to be moved along the X-axis direction and/or the Y-axis direction, where the X-axis and Y-axis directions are perpendicular to each other. The ionization chamber may be used to measure a dose size and/or a position of the beam. The adaptive collimator may form an adaptive aperture capable of self-adjusting according to the shape and size of a target region, enabling the shape and size of the particle beam to conform to the tumor morphology. Such adaptive irradiation can better adapt to irregularly shaped tumors, improving the personalization and targeting of irradiation plans. A combination of the components, such as the scanning magnet, the ionization chamber, a range shifter (also known as a range adjuster), and the adaptive collimator, enables the delivery of precise and flexible radiation therapy to patients.

The advantages of an integrated design in which the accelerator is mounted on the treatment gantry and capable of rotating together with the treatment gantry are as follows: it reduces system complexity by eliminating the need for a beam transport line, thereby simplifying the equipment structure; it also improves beam stability, since beam transport line inevitably introduces factors of beam instability, which the radiation therapy apparatus further lowers maintenance costs and failure rates without requiring a beam transport line and enhances the overall stability and reliability of the system; in addition, it minimizes the introduction of instability factors, allowing the beam to move more stably, which helps to maintain the stability of the particle beam and ensures precise irradiation.

What is claimed is:

1. An adjustment unit of a superconducting coil, comprising:
a rotating shaft connected to an external drive unit and capable of rotating driven by the external drive unit;
a drive assembly including an actuator and a tension assembly connected to each other, the actuator being configured to drive the tension assembly to move linearly through rotation, and one end of the tension assembly being connected to a superconducting coil and capable of driving the superconducting coil to move;
a transmission assembly connected to the rotating shaft and the actuator, respectively, and the transmission assembly being configured to drive at least a portion of the actuator to rotate by transmitting power generated by the rotating shaft to the actuator; and
a detection element connected to the actuator and configured to monitor a displacement of the tension assembly and a displacement of the superconducting coil by detecting a rotation angle of the actuator.

2. The adjustment unit of claim 1, wherein the transmission assembly includes a drive gear sleeved onto the rotating shaft and a driven gear fixedly connected to the actuator, and the drive gear is engaged with the driven gear to transmit the power from the rotating shaft to the actuator; and/or
the actuator is a differential screw, and an inner wheel of the differential screw is positioned lower than an outer wheel of the differential screw along a height direction of the adjustment unit.

3. The adjustment unit of claim 1, wherein the tension assembly is connected to a pressure detection member, and the pressure detection member is configured to detect a force exerted by the tension assembly on the superconducting coil; and/or
the detection element is a potentiometer.

4. The adjustment unit of claim 1, further comprising a limiting member and a housing, wherein the limiting member is connected to the tension assembly, the housing includes a limiting space for accommodating the limiting member, a wall of the limiting space is at least partially overlapped with the limiting member along a movement direction of the tension assembly, so that the wall of the limiting space limits a movement range of the limiting member; and/or
the housing is provided with a convex column capable of extending into the limiting space, and the convex column is disposed at one end of the tension assembly facing the superconducting coil to limit a movement range of the tension assembly.

5. The adjustment unit of claim 1, wherein one end of the tension assembly connected to the superconducting coil is provided with a connecting portion and a fixing member, the connecting portion includes a connecting cavity and a fixing hole in communication with the connecting cavity, the connecting cavity accommodates an adjustment assembly connected to the superconducting coil, and the fixing member inserts into the connecting cavity through the fixing hole and fixes the adjustment assembly.

6. An adjustment device of a superconducting coil, comprising:
an adjustment unit, wherein the adjustment unit includes:
a rotating shaft connected to an external drive unit and capable of rotating driven by the external drive unit;
a drive assembly including an actuator and a tension assembly connected to each other, the actuator being configured to drive the tension assembly to move linearly through rotation, and one end of the tension assembly being connected to a superconducting coil and capable of driving the superconducting coil to move;
a transmission assembly connected to the rotating shaft and the actuator, respectively, and the transmission assembly being configured to drive at least a portion of the actuator to rotate by transmitting power generated by the rotating shaft to the actuator; and
a detection element connected to the actuator and configured to monitor a displacement of the tension assembly and a displacement of the superconducting coil by detecting a rotation angle of the actuator;
the external drive unit, wherein the external drive unit is connected to the rotating shaft of the adjustment unit and configured to drive the rotating shaft to rotate; and
an adjustment assembly, wherein one end of the adjustment assembly is connected to the superconducting coil and the other end is connected to the tension assembly of the adjustment unit, and the tension assembly is configured to drive the superconducting coil to move through the adjustment assembly.

7. The adjustment device of claim 6, further comprising a control unit, wherein the control unit is connected to the detection element and the external drive unit, and the control unit is configured to receive detection information from the detection element and control an operation of the external drive unit.

8. The adjustment device of claim 6, wherein
one end of the tension assembly connected to the superconducting coil is provided with a connecting portion and a fixing member;
the adjustment assembly includes a tension rod, a first fitting member, and a second fitting member;
the first fitting member and the second fitting member are arranged on opposite ends of the tension rod, respectively;
the first fitting member is connected to the superconducting coil; and
the second fitting member is connected to the connecting portion of the tension assembly and is fixed relative to the tension assembly through the fixing member.

9. A cyclotron, comprising:
at least one adjustment device of a superconducting coil, wherein:
the at least one adjustment device includes:
an adjustment unit, wherein the adjustment unit includes:
a rotating shaft connected to an external drive unit and capable of rotating driven by the external drive unit;
a drive assembly including an actuator and a tension assembly connected to each other, the actuator being configured to drive the tension assembly to move linearly through rotation, and one end of the tension assembly being connected to a superconducting coil and capable of driving the superconducting coil to move;
a transmission assembly connected to the rotating shaft and the actuator, respectively, and the transmission assembly being configured to drive at least a portion of the actuator to rotate by transmitting power generated by the rotating shaft to the actuator; and
a detection element connected to the actuator and configured to monitor a displacement of the tension assembly and a displacement of the superconducting coil by detecting a rotation angle of the actuator;
the external drive unit, wherein the external drive unit is connected to the rotating shaft of the adjustment unit and configured to drive the rotating shaft to rotate; and
an adjustment assembly, wherein one end of the adjustment assembly is connected to the superconducting coil and the other end is connected to the tension assembly of the adjustment unit, and the tension assembly is configured to drive the superconducting coil to move through the adjustment assembly;
the superconducting coil; and
a mounting bracket, provided with a mounting space for accommodating the superconducting coil, wherein the mounting bracket includes at least one mating portion for mating with the at least one adjustment device, and the at least one adjustment device is configured to adjust a position of the mounting bracket and a position of the superconducting coil mounted inside the mounting bracket through the at least one mating portion.

10. The cyclotron of claim 9, wherein the cyclotron includes at least one adjustment device pair, two adjustment devices of an adjustment device pair of the at least one adjustment device pair is arranged at opposite ends of the superconducting coil, respectively, and the adjustment device pair is configured to adjust a position of the superconducting coil along an X-axis, a Y-axis, or a Z-axis, wherein the X-axis, Y-axis, and Z-axis are mutually perpendicular and intersect at a physical center of the cyclotron.

11. The cyclotron of claim 9, further comprising a plurality of magnetic field detection members, wherein the plurality of magnetic field detection members are spaced apart to measure magnetic field intensities at a plurality of positions within the cyclotron; or
the cyclotron further comprising a magnetic field detection device, wherein the magnetic field detection device includes a detection end and a drive component, the detection end is configured to detect a magnetic field intensity at a position where the detection end is located, and the drive component is configured to drive the detection end to move so as to measure the magnetic field intensities at a plurality of positions within the cyclotron.

12. An adjustment method for a superconducting coil, wherein the adjustment method is applied to the cyclotron of claim 9, and the adjustment method comprises:
obtaining an offset of the superconducting coil and obtaining a required adjustment amount for each of the at least one adjustment device based on the offset of the superconducting coil; and
controlling, by each of the at least one adjustment device, an operation of the external drive unit based on the required adjustment amount to drive the superconducting coil to be adjusted to a specified position.

13. The adjustment method of claim 12, further comprising:
monitoring, by the detection element, a rotation angle of the actuator driven by the external drive unit to obtain an actual adjustment amount of each of the at least one adjustment device, and stopping the external drive unit in response to determining that the actual adjustment amount of each of the at least one adjustment device is the same as the required adjustment amount for each of the at least one of adjustment device.

14. A radiation therapy apparatus, comprising the cyclotron of claim 9.
